(19) United States
(12) Patent Application Publication
(10) Pub. No.: US 2026/0092817 A1
(43) Pub. Date: Apr. 2, 2026

(54) SENSOR

(71) Applicant: TSB Co., Ltd., Tokyo (JP)

(72) Inventors: Kotaro HAYASHI, Tokyo (JP); Maiko MOMOI, Tokyo (JP); Koichi ICHIHARA, Tokyo (JP)

(73) Assignee: TSB Co., Ltd., Tokyo (JP)

(21) Appl. No.: 19/334,314

(22) Filed: Sep. 19, 2025

(30) Foreign Application Priority Data
Sep. 27, 2024 (JP) 2024-168001

(51) Int. Cl. G01K 1/08; G01K 7/00

(52) U.S. Cl. CPC G01K 1/08; G01K 7/00

(57) ABSTRACT

A sensor comprising: a housing 10 having an accommodation space 11 inside; a sensor chip 30 accommodated within the accommodation space 11; a pair of terminals 20 extending from an entrance 12 of the accommodation space 11 toward a depth direction of the accommodation space 11, and contacting a side surface of the sensor chip 30 in a width direction perpendicular to the depth direction; and wires 40 connected to the terminals 20, wherein the terminals 20 comprising two rod-shaped portions 21 that branch into two prongs within the accommodation space 11 and extend side by side in the width direction, one of the two rod-shaped portions 21 positioned on a sensor chip 30 side, elastically contacts the side surface of the sensor chip 30, while the other of the two rod-shaped portions 21 is arranged along a side wall in the width direction of the accommodation space 11.

### TECHNICAL FIELD

This invention relates to a sensor.

### TECHNICAL BACKGROUND

In recent years, temperature sensors are used in various devices such as home appliances, office automation equipment, ICT equipment, and automobiles. The temperature sensors used in these devices comprise a sensor chip having a pair of terminals on opposite sides and wires electrically connected to at least one of those terminals. As a configuration including such a sensor, Patent Document 1 describes a connector in which terminals are connected near the tips of two wires, the sensor chip is sandwiched between those two terminals, and the electrodes of the sensor chip are brought into contact with the terminals.

### PRIOR ART DOCUMENTS

### Patent Documents

Patent Document 1: Japanese Patent Application Publication No. 2021-38973

### SUMMARY OF THE INVENTION

### Problem to be Solved by the Invention

In sensors of the above type, there is a demand for structures and configurations that are easier to assemble.

The present invention was made in view of these circumstances and aims to provide a sensor with improved workability during assembly.

### Solutions for Solving the Problem

In order to achieve the above purpose, the sensor of the present invention comprises: a housing having an accommodation space: a sensor chip accommodated within the accommodation space: a pair of terminals extending from an entrance of the accommodation space toward a depth direction of the accommodation space, and contacting a side surface of the sensor chip in a width direction perpendicular to the depth direction; and wires connected to the terminals, wherein the terminals comprising two rod-shaped portions that branch into two prongs within the accommodation space, and extend side by side in the width direction, one of the two rod-shaped portions positioned on a sensor chip side, elastically contacts the side surface of the sensor chip, while the other of the two rod-shaped portions is arranged along a side wall in the width direction of the accommodation space.

With this configuration, the pair of terminals having the rod-shaped portions that branch into two directions and elastically contacting the side of the sensor chip, enables the sensor chip to be held by an elastic force that tends to narrow the distance between the pair of terminals. This allows for the realization of a sensor with simple and with good assembly workability.

The above sensor, wherein a tip of the other of the two rod-shaped portions of the terminals contacts an inner wall in the depth direction of the accommodation space.

This configuration enables easier positioning of terminals within the accommodation space. Furthermore, this improves the workability during the sensor assembly. Additionally, the enhanced positioning capability facilitates automation of the manufacturing process.

The above sensor, wherein a taper is formed on the one of the two rod-shaped portions of the terminals.

This configuration of the above taper facilitates insertion of the sensor chip between the pair of terminals, improving assembly workability.

The above sensor, wherein the terminals are pressure welded with the wires at an outside of the housing.

This configuration of the above allows to eliminate the need for a wire stripping process, and to simplify the assembly process.

The above sensor, wherein the terminals have a pressure welding portion that is pressure welded to the wires at an outside of the housing, and the pressure welding portion has a groove with a width narrower than a diameter of the wire, wherein the wire is deformed to conform to a shape of the groove and pressure welded with the terminals.

This configuration of the above enables wires and terminals pressure welding. This eliminates the need for wire stripping process, and simplifies the assembly process.

The above sensor may further comprise: a first pressure welding portion, wherein one of the pairs of the terminals is pressure welded with the wire; and a second pressure welding portion, wherein the other of the pairs of the terminals is pressure welded with the wire, positions of the first pressure welding portion and the second pressure welding portion are spaced apart along a longitudinal direction of the wire.

This configuration of the above allows connection by pressure welding even when using two connected wires.

The above sensor, wherein the sensor is configured to be formed by being covered with an outer shell made of an insulating material, which includes the housing accommodating the sensor chip and the pair of terminals.

This configuration of the above enables to protect the sensor chip and the pair of terminals contained within the sensor from short circuits and electrical interference. And it also reduces susceptibility to external environmental influences, and stabilizes sensor signals.

### Effect of the Invention

With this configuration, the sensor may achieve good workability during assembly.

### BRIEF DESCRIPTION OF THE DRAWINGS

FIG. 1 is a side cross-sectional view showing a configuration of a sensor according to an embodiment;

FIG. 2 is a cross-sectional view showing a configuration along line A-A in FIG. 1 of a sensor according to an embodiment:

FIG. 3 is partial cross-sectional view showing a configuration along line B-B in FIG. 1 of a sensor according to an embodiment:

FIG. 4 is a perspective view showing a portion of a configuration of a sensor according to an embodiment:

FIG. 5 is a perspective view showing a configuration of a sensor according to an embodiment:

FIG. 6 is a partially enlarged cross-sectional view showing a configuration along line A-A in FIG. 1 of a sensor according to an embodiment:

FIG. 7 is a partially enlarged side cross-sectional view showing a configuration of a sensor according to an embodiment:

FIG. 8 is an enlarged view showing a configuration of a wire pressure welding portion of an embodiment:

FIG. 9 is an enlarged view showing a configuration of a wire pressure welding portion of an embodiment:

FIG. 10 is a schematic diagram showing a configuration of a terminal of an embodiment:

FIG. 11 is a flowchart showing a method of manufacturing the sensor of a embodiment:

FIG. 12 is a perspective view showing a configuration of a sensor according to a method of manufacturing of an embodiment.

### DESCRIPTION OF THE EMBODIMENTS

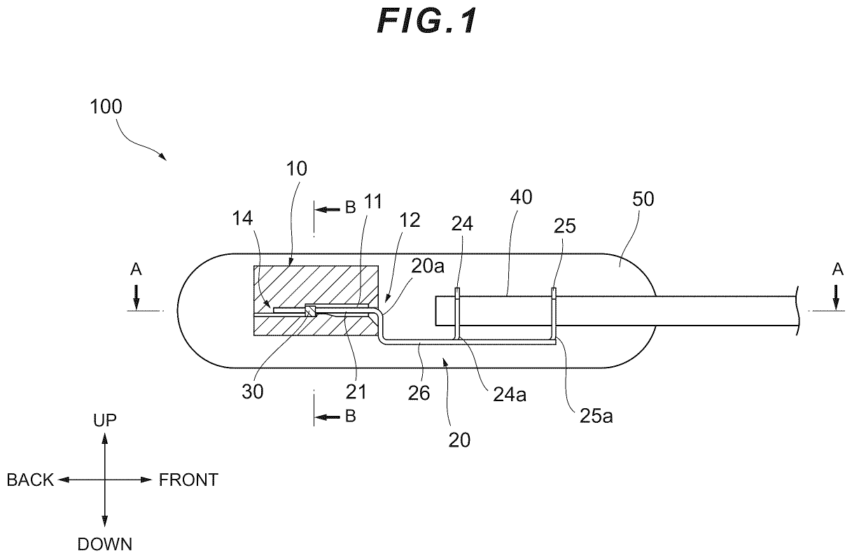

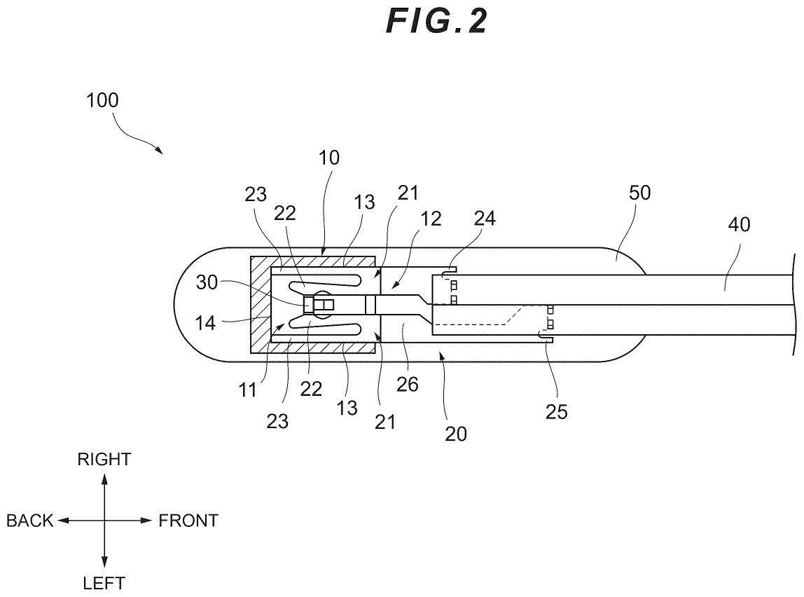

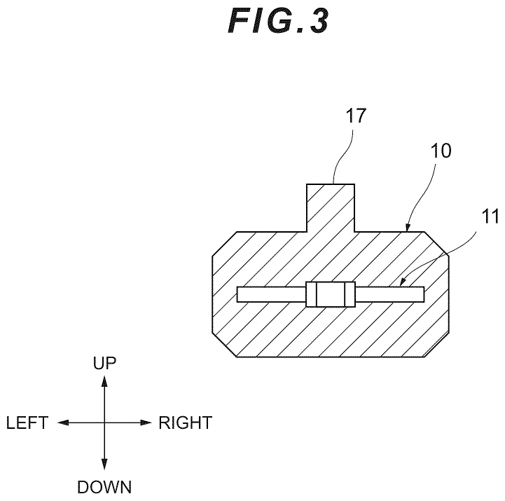

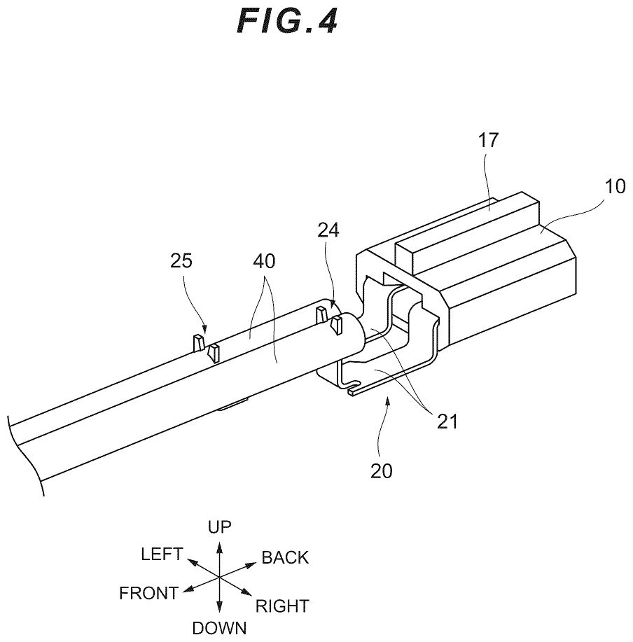

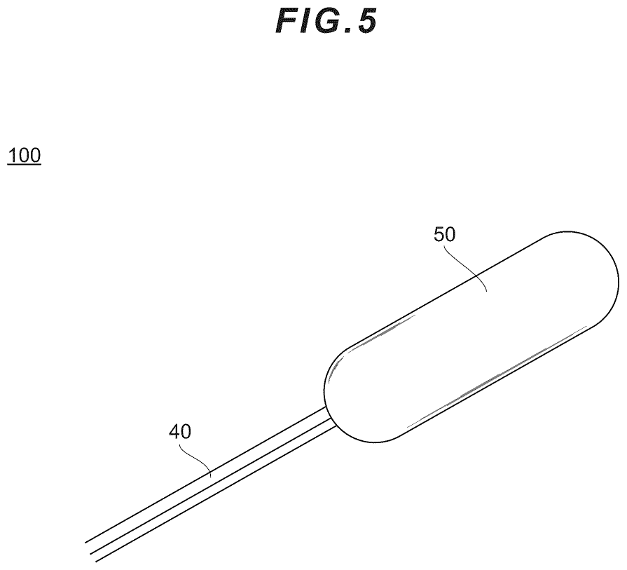

Hereinafter, embodiments according to the present invention will be described with reference to FIGS. 1 to 5. FIG. 1 is a side cross-sectional view, FIG. 2 is a top view of the cross-section along line A-A in FIG. 1, FIG. 3 is a cross-sectional view along line B-B in FIG. 1, and FIGS. 4 and 5 are perspective views, showing a configuration of a sensor 100 according to an embodiment of the present invention. Note that FIGS. 3 and 4 show only the internal configuration of an outer shell 50, omitting the description of the outer shell 50 itself. In the following description as indicated by the arrow in the side view of FIG. 1, the longitudinal direction of the sensor 100 is referred to as the front-to-back direction, the transverse direction (width direction) as the left-to-right direction, and the height direction as the up-to-down direction.

The sensor 100 is used in electronic devices such as home appliances, office automation equipment, ICT equipment, and automobiles, and is connected within a circuit for use. The sensor 100 comprises an insulating housing 10, a terminal 20 with one end inserted into the housing 10, a sensor chip 30 held by the terminal 20, a wire 40 connected to the other end of the terminal 20, and an outer shell 50 covering part of the housing 10, the terminal 20, and the wire 40.

The housing 10 is formed using an electrically insulating material such as synthetic resin. The housing 10 contains an accommodation space 11, into which the sensor chip 30 and a rod-shaped portion 21 which is a part of terminal 20 that holds sensor chip 30 are inserted. A protrusion 17, having a roughly rectangular prism shape in the front-to-back direction, is formed on the top surface of the housing 10. The protrusion 17 facilitates determining the up/down orientation during machine assembly. The accommodation space 11 extends from the entrance 12 in the depth direction (i.e., the back direction) and is enclosed by left and right-side walls 13 and an inner wall 14 in the depth direction. The structure of the accommodation space 11 will be described in more detail later.

The terminal 20 is formed of conductive material and consists of two terminals arranged in parallel and symmetrically to each other in the left-right direction, forming a pair. Each of the terminals 20 has a rod-shaped portion 21 at one end, which is inserted into the accommodation space 11 of the housing 10, and wire pressure welding portions 24, 25 at the other end, which connect to wires 40. The rod-shaped portion 21 and the wire pressure welding portions 24, 25 are each connected by a terminal arm portion 26. Note that the pair of terminals 20 are connected by the carrier portion 64 during the manufacturing of the sensor 100, as described later, but in the finished product, they are not connected to each other. The terminal 20 is configured such that it bends downward in an L-shape at the base 20a of the rod-shaped portion 21 on the terminal arm portion 26 connected to the rod-shaped portion 21. It then bends forward in an L-shape toward the front where wire 40 is connected. Finally, it bends upward in an L-shape at the bases 24a and 25a of the wire pressure welding portions 24 and 25, respectively: at the other end. The L-shaped bending of terminal arm portion 26 enables the formation of wire pressure welding portions 24, 25 capable of holding wire 40 at the opposite end of the same plate as terminal 20, while also aligning the vertical height between the center position of the sensor chip 30 and the center position of wire 40. Aligning the heights of the center positions of the sensor chip 30 and the wire 40 enables the entire sensor to be miniaturized and also makes it easier to handle. The terminal arm portion 26 may also be straight without being bent, and the shape of the bent terminal arm 26 need not be L-shaped.

The terminal 20 has a rod-shaped portion 21, which is inserted into the accommodation space 11 from the base 20a to the tip of the rod-shaped portion 21. The rod-shaped portion 21 has a tip that bifurcates into two branches, left and right. The branch positioned inside each of the pair of terminals 20 is formed shorter than the other branch. The sensor chip 30 is held between these shorter rod-shaped holding portions 22. The rod-shaped assisting portions 23, positioned on the outer side of the rod-shaped holding portion 22 in the left/right direction, are inserted along the side wall 13 of the accommodation space 11 until those tips contact the inner wall 14 in the depth direction (back direction) of the accommodation space 11. This bifurcated structure allows the rod-shaped holding portion 22 to elastically deform relative to the rod-shaped assisting portion 23. The spacing between the rod-shaped holding portions 22 in the pair of terminals can be expanded by the sensor chip 30, thereby providing an clastic force to the rod-shaped holding portion 22 for holding the sensor chip 30.

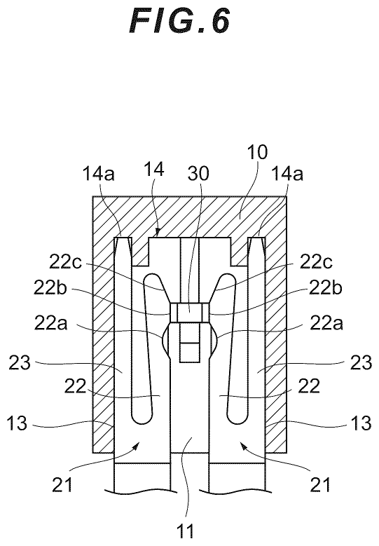

Referring to FIG. 6 below: the rod-shaped holding portion 22 will be described. FIG. 6 is an enlarged cross-sectional view of the rod-shaped portion 21 at line A-A in FIG. 1. The tip portion of the rod-shaped portion 22 is formed with a taper that narrows in width toward the depth direction (back direction) of the accommodation space 11. Specifically, the width of the rod-shaped portion 22 narrows from the widest portion (hereinafter referred to as the “wide portion”) 22b toward the tip 22c, and the spacing between the two rod-shaped holding portion 22 is configured to widen toward the tip 22c. This taper formed on the rod-shaped portion 21 makes it easier to insert the sensor chip 30 between the pair of terminals 20 from the tip 22c side. After the terminals 20 are inserted into the accommodation space 11, the sensor chip 30 is held at the portion where the respective wide portion 22b of the two rod-shaped holding portions 22 face each other. Furthermore, a recessed portion 22a is formed where the width of the rod-shaped portion 22 locally narrows in the front direction of the wide portion 22b. The recessed portion 22a serves to distribute stress applied to the rod-shaped portion 22 when it undergoes elastic deformation.

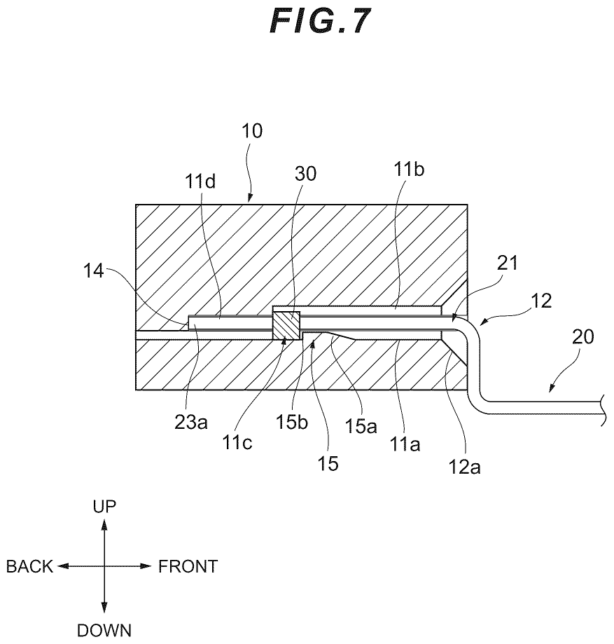

To describe the insertion process of the rod-shaped portion 21 into the housing 10, the structure of the accommodating space 11 is again explained using FIGS. 6 and 7. FIG. 7 is a side cross-sectional view of the sensor 100, showing a partially enlarged portion near the housing 10. The entrance 12 has an insertion opening 12a with its bottom surface 11a flared outward from the housing 10, allowing the rod-shaped portion 21 to be easily guided and inserted. The structure of the insertion opening 12a may be provided on the upper side of the entrance 12: by being provided on bottom and/or upper side, it allows for easy insertion while being adequately secured. On the bottom surface 11a of the accommodation space 11, a stopper 15 with a protruding structure is formed along the path extending from the entrance 12 toward the rear. This structure features an upward slope 15a toward the rear and a downward step 15b continuing downward. The top surface 11b of the accommodation space 11 is formed lower than the top surface 11d slightly behind this stopper 15. The bottom surface 11a and the top surface 11b together create a space 11c behind the stopper 15 where the sensor chip 30 can be housed. Note that, the stopper 15 need only be positioned near the location where the sensor chip 30 passes during insertion and have a width approximately equal to that of the sensor chip 30: it need not extend across the full width of accommodation space 11. As shown in FIG. 6, a portion of the inner wall 14 in the depth direction has a shorter length, forming a groove 14a capable of accommodating the tips of the left and right rod-shaped assisting portions 23 due to this difference in length in the depth direction.

When inserting the rod-shaped portion 21 into the housing 10, the sensor chip 30 is first accommodated in the space 11c behind the stopper 15 within the accommodating space 11. The sensor chip 30 is prevented from shifting toward the front within the space 11e by the step 15b provided within the accommodation space 11. Furthermore, the structure of the top surface 11d prevents it from shifting toward the rear. This allows the sensor chip 30 to be fixed within the housing 10. Subsequently; insert the rod-shaped portion 21 until the tip of the rod-shaped assisting portion 23 contacts the inner wall 14 of the groove 14a in the depth direction. This causes the tip 22c of the rod-shaped holding portion 22 to be pushed outward laterally by the sensor chip 30. Further insertion causes the sensor chip 30 to be elastically held at the wide portion 22b. The rod-shaped assisting portion 23 is tapered toward its tip, facilitating insertion into the groove 14a. The inner wall 14 in the depth direction need not necessarily have a groove 14a formed: FIG. 2 shows a case where no groove 14a is formed. Thus, by inserting the sensor chip 30 into the accommodation space 11 beforehand, insertion of the terminal 20 into the accommodation space 11 becomes easier. This facilitates handling of parts during assembly work.

The method described above involves inserting the sensor chip 30 into the accommodation space 11 first. However, the sensor chip may also be inserted into the housing space 11 together with the rod-shaped portion 21 when inserting the rod-shaped portion 21 into the housing 10. In that case, the sensor chip 30 is inserted while temporarily held by the tapered portion formed from the tip 22c to the wide portion 22b of the rod-shaped holding portion 22. Furthermore, as the rod-shaped portion 21 is inserted with the sensor chip 30 into the space 11c behind the stopper 15 shown in FIG. 7, the sensor chip 30 is accommodated within the space 11c while being held by the rod-shaped holding portion 22. Due to the structure of the accommodating space 11 described above, when the sensor chip 30 is inserted, the sensor chip 30 moves smoothly along the upward slope 15a into the space 11c. Furthermore, when the rod-shaped portion 21 is inserted until the tip of the rod-shaped assisting portion 23 contacts the inner wall 14 at the rear of the accommodation space 11, the contact point between the sensor chip 30 and the rod-shaped holding portion 22 moves along the taper shape to the wide portion 22b. It is then elastically held between the rod-shaped holding portion 22 at the narrowed wide portion 22b.

The sensor chip 30 is formed as a rectangular plate-like device capable of outputting information about changes in the detected target, such as temperature changes, as an electrical signal. Electrodes are formed on the side surface of the sensor chip 30. By holding the sensor chip 30 and the terminal 20 in electrical connection by bringing the side surface into contact with the rod-shaped holding portion 22, electrical connection between the sensor chip 30 and the terminal 20 is achieved.

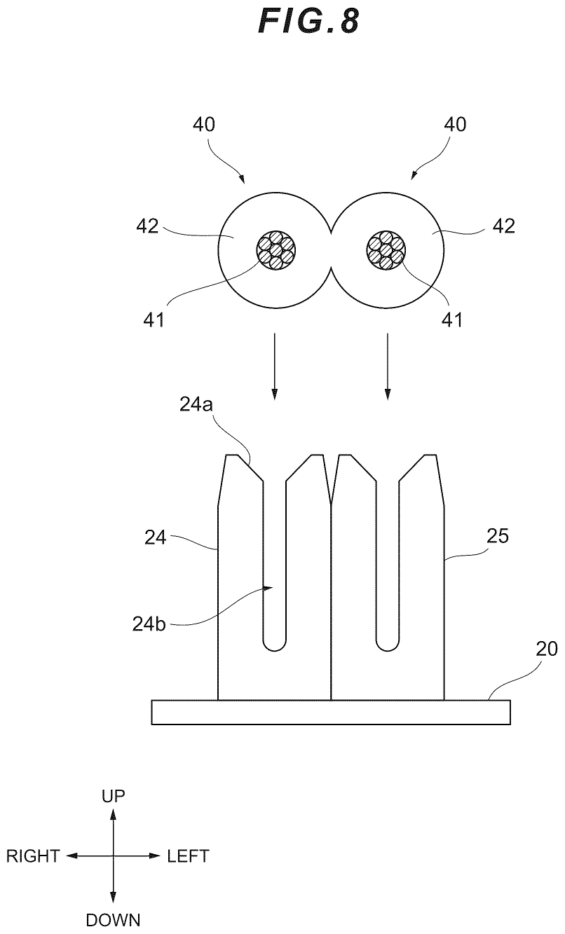

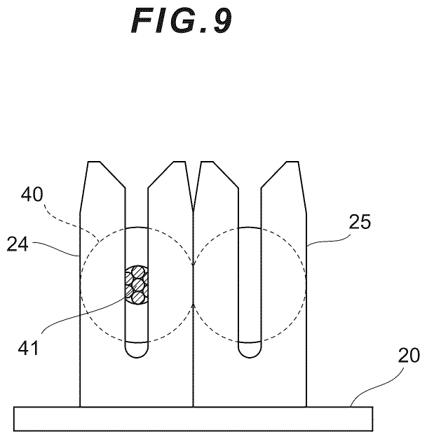

Next, the wire pressure welding portion 24 and 25 at the other end of the rod-shaped portion 21 of the terminal 20 are described. As shown in FIG. 2, the wires 40 are pressure welded to the terminal 20 in parallel to each other in the left-right direction. The wire pressure welding portions 24 and 25 are spaced apart in the front-to-back direction on the terminal 20, which is the longitudinal direction relative to the wires 40. FIGS. 8 and 9 show the appearance of the wire pressure welding portions 24 and 25 when viewed from the rod-shaped portion 21 side towards the wires 40. The upper view in FIG. 8 is a cross-sectional view of the wire 40. Wire 40 is covered with an insulating sheath 42 around a core wire 41 composed of a plurality of conductors. The wire pressure welding portions 24 and 25 are formed by bending upward from the terminal arm portion 26 at the base 24a. At the upper end of the terminal pressure welding portions 24 and 25, an opening 24a is formed, which has a cross-sectional shape opening outward in an inverted V-shape (opening upward). From opening 24a, a groove-shaped pressure welding groove 24b is formed extending downward, having a width slightly narrower than the diameter of the core wire 41. Extending downward from the opening 24a is a groove-like pressure welding groove 24b, whose width is slightly narrower than the diameter of the core wire 41. When the wire 40 is pushed from the opening 24a into the pressure welding groove 24b, the sheath 42 of the wire 40 tears. Within the pressure welding groove 24b, the core wire 41 is crushed to conform to the shape of the pressure welding groove 24b, causing the wire pressure welding portions 24, 25 and the core wire 41 to contact and pressure weld together. This structure eliminates processes such as stripping the wire 40's sheath 42 or soldering the stripped core wire 41. The wire 40 and the terminal 20 are thus electrically connected. FIG. 9 shows a cross-sectional schematic diagram of the wire 40 and the wire pressure welding portion 24 after pressure welding. Under the above structure, by arranging the wire pressure welding portions 24 and 25 spaced apart in the front-back direction, physical interference between the wire pressure welding portions 24 and 25 can be avoided even when using wire 40 connected in parallel left and right. This configuration allows adaptation to wire 40 having a shape where two wires are connected in parallel, as shown in the upper view of FIG. 8.

Returning to FIG. 1, the outer shell 50 will now be described. The outer shell 50 is composed of an electrically insulating material such as resin. The outer shell 50 covers, from the outside, the terminal 20 holding the sensor chip 30, the housing 10 into which this terminal 20 is inserted, and a portion of the wire 40 connected to the terminal 20. FIG. 5 shows the state after being covered and molded by the outer shell 50. Covering with the outer shell 50 improves the sensor 100's resistance to vibrations and impacts, increases its mechanical strength, and enhances its electrical insulation.

Thus, according to the sensor 100 of this embodiment, it is possible to configure a sensor with excellent assembly workability.

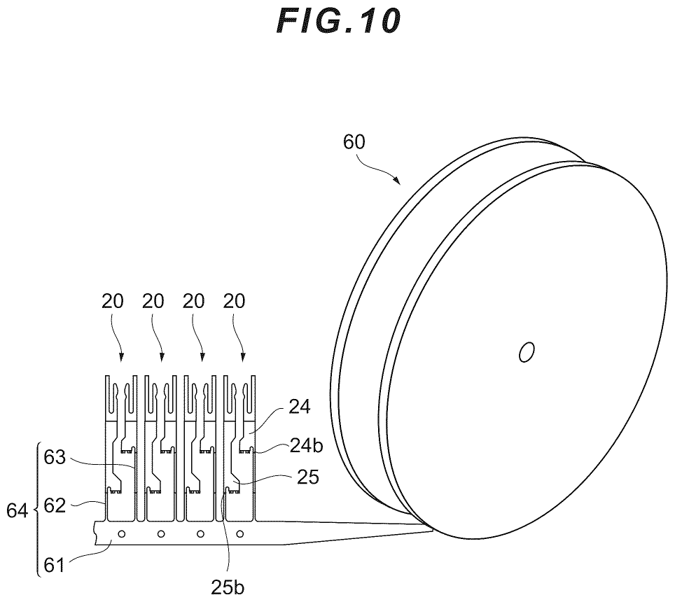

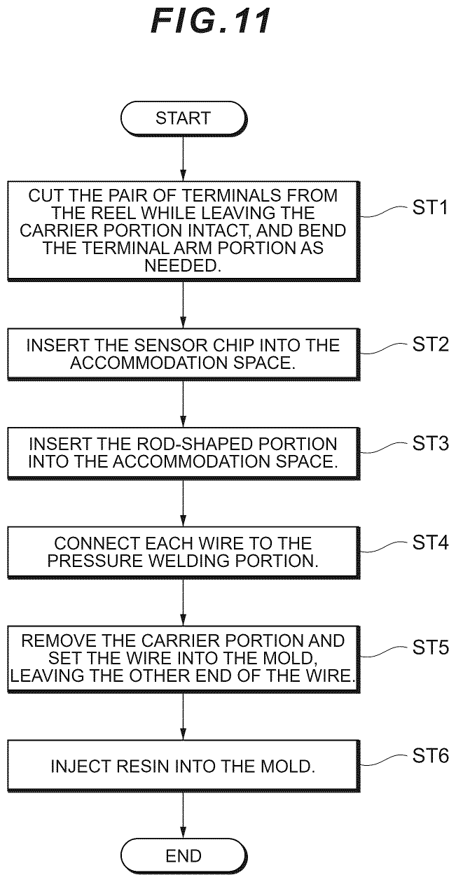

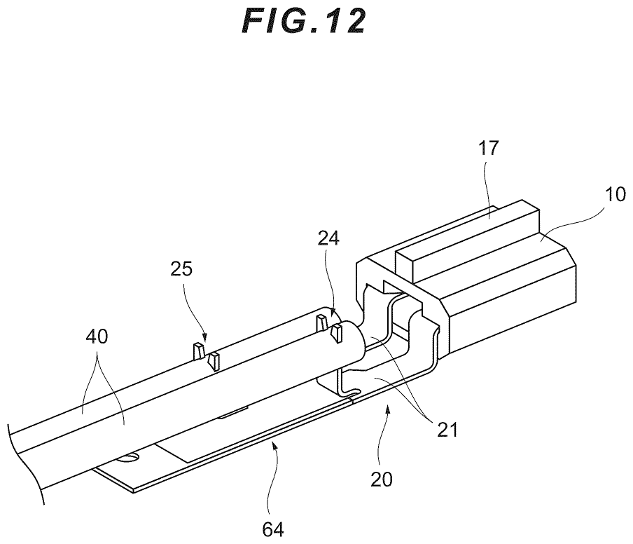

Next, the method of manufacturing for the sensor 100 is explained using FIG. 10 and the flowchart in FIG. 11. Before assembly, terminal 20, which constitutes the sensor 100, is in a state numerous terminals 20 are wound onto a reel 60 in a reel-like configuration. FIG. 10 is a schematic diagram showing the state where the tip portion has been slightly pulled out from this reel 60. The terminals 20 are arranged in pairs in parallel on a winding portion 61, which is wound in a reel-like configuration. The terminals 20 and the winding portion 61 are connected via connection portions 62 and 63 to the ends 24b, 25b of the bases 24a, 25a of wire pressure welding portions 24, 25. Separate the pair of terminals 20 while leaving the carrier portion 64 consisting of the winding portion 61 and connecting portions 62 and 63 intact, and bend the terminal arm portion 26 as necessary (step ST1). Next, insert the sensor chip 30 into the accommodation space 11 as described above (step ST2), insert the rod-shaped portion 21 into the accommodation space 11 (step ST3), and connect wires 40 to each terminal pressure welding portions 24, 25 (step ST4). FIG. 12 shows a perspective view of the assembled sensor 100 up to this step. As shown in FIG. 12, the carrier portion 64 is still remained at this step and is removed before the molding step that covers the entire assembly with the outer shell 50. Remove the carrier portion 64 from the sensor 100 shown in FIG. 12, and set the wires 40 into the mold, leaving the other end of the wires 40 that are not being pressure welded (step ST5). Inject resin over it and complete the sensor 100 by injection molding (step ST6). Step ST1 through step ST6 need not necessarily be performed in this order. However, assembling with the carrier portion 64 remaining until the terminal 20 position is fixed eliminates the need for jigs during assembly, thereby improving assembly workability.

The above configuration enables the provision of a sensor with improved assembly workability: Although the sensor 100 of this embodiment is described assuming a temperature sensor, it may also be an acceleration sensor and can be applied to various types of other sensors.

In this embodiment, the electrical connection between the terminal 20 and the wire 40 is made by pressure welding the wire pressure welding portions 24, 25 to the wire 40. However, the method of electrical connection is not limited to pressure welding. Alternatively, the terminal 20 and the wire 40 may be electrically connected by methods such as soldering, crimping, or piercing.

The present invention is not limited to the above embodiments and may be improved as appropriate within the scope of the essence of the invention.

### EXPLANATION OF NUMERALS AND CHARACTERS

100 Sensor
10 Housing
11 Accommodation space
20 Terminal
30 Sensor chip
40 Wire
50 Outer shell

1. A sensor comprising:
a housing having an accommodation space inside;
a sensor chip accommodated within the accommodation space;
a pair of terminals extending from an entrance of the accommodation space toward a depth direction of the accommodation space, and contacting a side surface of the sensor chip in a width direction perpendicular to the depth direction; and
wires connected to the terminals,
wherein
the terminals comprising two rod shaped portions that branch into two prongs within the accommodation space and extend side by side in the width direction, one of the two rod-shaped portions positioned on a sensor chip side, elastically contacts the side surface of the sensor chip, while the other of the two rod-shaped portions is arranged along a side wall in the width direction of the accommodation space.

2. The sensor according to claim 1, wherein a tip of the other of the two rod-shaped portions of the terminals contacts an inner wall in the depth direction of the accommodation space.

3. The sensor according to claim 1, wherein a taper is formed on the one of the two rod-shaped portions of the terminals.

4. The sensor according to claim 1, wherein the terminals are pressure welded with the wires at an outside of the housing.

5. The sensor according to claim 1, wherein the terminals have a pressure welding portion that is pressure welded to the wires at an outside of the housing, and the pressure welding portion has a groove with a width narrower than a diameter of the wire, wherein the wire is deformed to conform to a shape of the groove and pressure welded with the terminals.

6. The sensor according to claim 4, further comprising:
a first pressure welding portion, wherein one of the pairs of the terminals is pressure welded with the wire; and
a second pressure welding portion, wherein the other of the pairs of the terminals is pressure welded with the wire,
positions of the first pressure welding portion and the second pressure welding portion are spaced apart along a longitudinal direction of the wire.

7. The sensor according to claim 1, wherein the sensor is configured to be formed by being covered with an outer shell made of an insulating material, which includes the housing accommodating the sensor chip and the pair of terminals.
